(19) United States
(12) Patent Application Publication
(10) Pub. No.: US 2025/0271316 A1
(43) Pub. Date: Aug. 28, 2025

(54) SYSTEMS AND METHODS FOR A PRESSURE-SENSITIVE COATING

(71) Applicant: The Charles Stark Draper Laboratory, Inc., Cambridge, MA (US)

(72) Inventors: Alket MERTIRI, Medford, MA (US); Melissa SPRACHMAN, Somerville, MA (US); Michael TURO, Cambridge, MA (US); Isaac MORAN, Maynard, MA (US); Kimberly KELLY, Cambridge, MA (US); Devon BECK, Cambridge, MA (US)

(21) Appl. No.: 19/065,124

(22) Filed: Feb. 27, 2025

Related U.S. Application Data
(60) Provisional application No. 63/558,619, filed on Feb. 27, 2024.

(51) Int. Cl. G01L 7/10; B82Y 20/00; C09D 5/22; C09D 7/61; C09K 11/88

(52) U.S. Cl. CPC G01L 7/102; B82Y 20/00; C09D 5/22; C09D 7/61; C09K 11/883; G01L 7/106

(57) ABSTRACT

Systems and methods for detecting pressure changes is provided. A system can include an object having a surface. The system can include a coating having microcapsules. The coating can be a pressure-sensitive paint configured to emit fluorescence outside of a threshold pressure. The coating can adhere to the surface of the object and receive an application of a pressure from a source. The coating can change at least a portion of the microcapsules from a first state to a second state responsive to the application of the pressure meeting a threshold pressure. The system can include an image capture device configured to capture images of the coating to identify a change in pressure at a portion of the object.

### CROSS-REFERENCE TO RELATED APPLICATIONS

This application claims the benefit of U.S. provisional Application No. 63/558,619 filed Feb. 27, 2024, the disclosure of which is incorporated in its entirety by reference herein.

### TECHNICAL FIELD

Aspects of the disclosure generally relate to systems and methods for using pressure sensitive particles to provide pressure feedback during operation of moving object. In particular, the systems and methods disclosed herein relate to a coating to identify a change in pressure.

### BACKGROUND

In the biomedical space, colloidal nanoparticles (hereinafter, interchangeably, quantum dots) can be used to fluoresce targets to which the nanoparticles adhere. These nanoparticles have unique optical and electronic properties that occur due to the confinement of electrons within a quantum sized particle which causes a discretization of the electrons' energy states. Quantum dots are advantageous because they have high photostability, can be used for multicolor imaging using a single excitation wavelength, have a high brightness, a relatively long lifetime, and a high surface-area-to-volume ratio. In some instances, nanoparticles can be used for applications where a stable fluorescent signal is needed for detection, such as pressure detection.

Gauges, instruments, or other tools can identify a change in pressure that can occur due to air, pressure, tampering, or vacuum leaks, among others. While these tools are all useful for detecting pressure, they are often limited in their ability to detect surface pressure changes, or pressure changes that occur on moving objects.

### SUMMARY

Presented herein are systems and methods for detecting pressure changes. A system can include an object having a surface. The object can be exposed to a pressure, such as an atmospheric pressure, air pressure, vacuum pressure, mechanical pressure, or other such pressure. In some cases, a pressure can be outside of a threshold pressure for the object. For example, an object may have a maximum atmospheric pressure, a minimum air pressure, a range of physical compression, or other such threshold which can be exceeded or not met. Pressures not meeting a threshold exerted upon the object or its surface can have detrimental effects on the performance, integrity, or structure of the object. For example, an application of a pressure not meeting the threshold can cause structural failures or damages to the object.

In some cases, persons or devices associated with the object can be subject to harmful effects as a result of a pressure change. For example, the object can be a room and the surface can be one or more walls, floors, or ceilings of the room. In some cases, a threshold pressure of a room can correspond to a pressure within a range to enable human life, such as within one atmosphere, for example. This can occur, for example, within a pressure-controlled environment in a vehicle such as a submarine, space shuttle, airplane, elevator, among others. In such instances, an application of a pressure not meeting the threshold can be harmful to not only the object but also to persons or devices associated with the object.

Identifying changes or applications of pressure can be difficult for certain objects, such as rooms, vehicles, electronic devices, food, or other such objects. In some cases, the change in pressure can be so small that it is difficult to detect by conventional means. In some cases, the change in pressure can be applied on a portion or subset of the object. Identifying a location of a pressure change can thereby prove difficult while having large consequences for the object or persons or devices associated with it.

To account for these and other technical problems, the surface can have a coating adhered to it. The coating can include microcapsules configured to change state (e.g., burst, change shape, color, luminescence, fluorescence, etc.) upon an application of a pressure that meets a threshold. In some cases, a portion of the coating can change state upon application of a pressure, such as application of the pressure on the portion of the coating. In some cases, the entire coating or a substantial portion can change state, responsive to a detection of a change of pressure of the environment of the coating. In some cases, the change of state of the coating can be identified by a light.

By applying a pressure-sensitive coating to one or more surfaces of an object, the systems and methods described herein can detect changes in pressure due to an environment or mechanical application, among others. Furthermore, by applying a light to identify changes in the coating, the system can simplify identification of pressure-fault areas, such as fluid leaks, undue stresses, etc. As such, the systems and methods described herein provide an improvement to the detection and identification of pressure changes to an object.

At least one aspect of the present disclosure is directed to a system for detecting pressure changes. The system can include an object. The object can have a surface. The system can include a coating. The coating can have microcapsules. The coating can adhere to the surface of the object. The coating can receive an application of a pressure from a source. The system can change at least a portion of the microcapsules from a first state to a second state responsive to the application of the pressure meeting a threshold pressure.

At least one aspect of the present disclosure is directed to a method for detecting pressure changes. The method can include adhering a coating having microcapsules to the surface of an object. The method can include receiving an application of a pressure to the coating. The method can include determining that at least a portion of the microcapsules changed from a first state to a second state responsive to the application of the pressure meeting a threshold pressure.

### BRIEF DESCRIPTION OF THE DRAWINGS

The foregoing and other objects, aspects, features, and advantages of the disclosure will become more apparent and better understood by referring to the following description taken in conjunction with the accompanying drawings. The accompanying drawings are not intended to be drawn to scale. Like reference numbers and designations in the various drawings indicate like elements. For purposes of clarity, not every component may be labeled in every drawing. In the drawings:

FIG. 1 illustrates a block diagram of a system for detecting pressure changes with a pressure-sensitive coating;

FIG. 2 illustrates a view of detecting pressure changes in an object with a pressure-sensitive coating;

FIGS. 3A-3C illustrates a process for detecting pressure changes in an object with a pressure-sensitive coating;

FIG. 4 illustrates a flow of a method of detecting pressure changes with a pressure-sensitive coating; and

FIG. 5 illustrates a block diagram of detecting pressure changes with a pressure-sensitive coating.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

Described herein are systems and methods for detecting pressure changes. A system can include an object having a surface. In some cases, a pressure can be outside of a threshold pressure for an object due to an application of another object, fluid leaks, tampering, among others. For example, an object may have a maximum atmospheric pressure, a minimum air pressure, a range of physical compression, or other such threshold which can be exceeded or not met. Pressures not meeting a threshold exerted upon the object or its surface can have detrimental effects on the performance, integrity, or structure of the object. Furthermore, persons or devices associated with the object can be subject to harmful effects as a result of a pressure change. This can occur, for example, within a pressure-controlled environment in a vehicle such as a submarine, space shuttle, airplane, elevator, among others. Identifying changes or applications of pressure can be difficult due to a form factor of an object, quantity or size of the pressure change, among others. Identifying a location of a pressure change can thereby prove difficult while having large consequences for the object or persons or devices associated with it.

The system and methods described herein can provide a coating to adhere to one or more surfaces of the object. The coating can include microcapsules of encapsulated quantum dots configured to change state (e.g., demonstrate fluorescence) upon an application of a pressure that meets a threshold. In certain examples, the application of pressure results in oxygen concentration changes on the coating, which allows for the change in state of the quantum dot to demonstrate fluorescence. In that regard, the microcapsules may be oxygen impermeable such that the pressure changes the state of the coating. By applying a pressure-sensitive coating to the surface, the technical solutions described herein can detect changes in pressure due to an environment or mechanical application, among others. Furthermore, by applying a light to identify changes in the coating, the system can simplify identification of pressure-fault areas, such as fluid leaks, undue stresses, etc. As such, the systems and methods described herein provide an improvement to the detection and identification of pressure changes to an object.

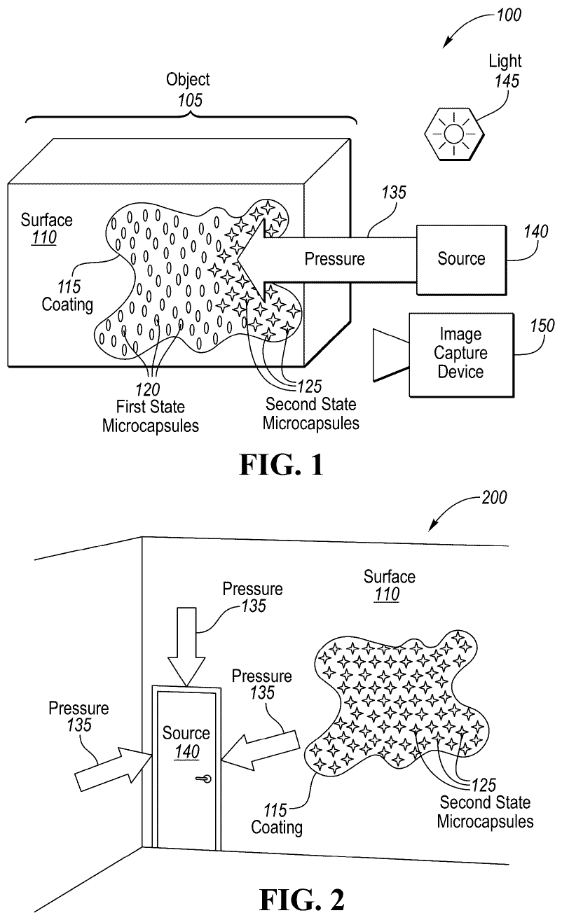

FIG. 1 depicts a block diagram of a system 100 for detecting pressure changes with a pressure-sensitive coating. The system 100 can include an object 105, a source 140, an image capture device 150, or a light 145 among others. The object 105 can include one or more surfaces 110 on which a coating 115 can be adhered. The coating 115 can include one or more microcapsules 120 and 125 in a first state or a second state, respectively. In brief overview of the system 100, the source 140 exerts a pressure 135 on the surface 110 of the object 105. The pressure 135 causes a subset of the microcapsules to change from first state microcapsules 120 to second state microcapsules 125. The light 145 can demonstrate the one or more states of the coating 115. The image capture device 150 can capture images of the coating 115 during any state of the microcapsules and before, during, or after an application of the pressure 135. Embodiments may comprise additional or alternative components or omit certain components from those of FIG. 1, and still fall within the scope of this disclosure.

The object 105 can be one or more objects, rooms, devices, enclosures, or other objects which can experience a pressure. In some cases, the object 105 is a room of a building. For example, the object can be a cabin of a vehicle, a pressure-controlled chamber, or an airflow-controlled room. In some cases, the object can be a vehicle, such as an airplane, space shuttle, submarine, car, train, or other such vehicle which can be exposed to an application of the pressure 135. In some cases, the object can be an enclosure, such as a box, storage unit, capsule, or container. In some cases, the object can be a device, such as an electronic device like a logic device, programmable board, PCB, etc.

The object 105 can have one or more surface(s) 110. The surface 110 can be any side, covering, or perimeter of the object 105. In some cases, the surface 110 can be an external surface of the object 105. An external surface 110 of the object 105 can be exposed to an external environment. In some cases, the surface 110 can be an internal surface of the object 105. An internal surface 110 of the object 105 can be exposed to an internal environment, such as within a room of a chamber or enclosure. For example, for an object 105 of a room, the surface 110 can be a wall of the room. For example, for an object 105 of an electronic device, the surface 110 can be one or more particular chips of the electronic device. For example, for an object 105 of an airplane, the surface 110 can be one or more wings of an airplane exposed to the flying environment. These examples are not meant to be exclusive and can include various other objects and surfaces.

In some cases, the object can contain persons, devices, or other objects. For example, a vehicle object 105 can include one or more persons. For example, an enclosure object 105 can include food, devices, or other such objects. The surface 110, the object 105, or persons or objects contained within the object 105 can be subject to pressures. These pressures can be or include mechanical pressures, such as those exerted by a fluid, object, or vacuum, among others. In some cases, the object can withstand or operate within a threshold pressure. For example, an object 105 submarine can be operational within a threshold pressure within a specified depth of the sea. For example, an object 105 airplane wing can be operational within a threshold pressure exerted by wind or air upon the wing.

In some cases, the source 140 can provide the pressure 135 outside the threshold pressure for the object 105. For example, the source 140 can be a leak in an airlock chamber which exudes air to exert a negative pressure on the object 205 or the surface 110 of the object 105. For example, the source 140 can be a human, airflow, environment, fluid, other object, impact, etc. that exerts an application of a mechanical pressure upon the object 105 that is outside of a threshold range of pressure for the object 105.

For example, the source 140 can be a hypersonic environment. The source 140 can exert the pressure 135 of a hypersonic pressure. For example, the object 105 can be an airlock chamber. The source 140 can be an external environment at a different pressure or fluid level of the airlock chamber. In this manner, the source 140 can cause leaks in the airlock chamber. In some cases, the object 105 can be infrastructure, such as a building, room, bridge, etc., and can be subject to the pressure 135 from general operation of the infrastructure, gravity, among other pressures. In some cases, the object 105 can be a medical device such as microfluidics channel. The source 140 can be a leak, crack, or fluid flown throughout the microfluidics channel. In some cases, the source 140 can be a human, tool, or other way by which to tamper with the object 105. By tampering with the object 105, the source 140 can apply the pressure 135. In some cases, the object 105 can be an enclosure for food or drugs such as a lock box, medicine tube, vial, among others, and the source 140 can be an external environment which can affect freshness or viability of the food or drug. In some cases, the source 140 can be an external environment such as outer space. The source 140 can apply the pressure 135 such as a vacuum, air loss, or other such pressure to a shuttle chamber, space suit, or other object 105 suited for use in an extreme environment such as outer space.

To detect the pressure 135 exerted by the source 140, the object 105 can have a coating 115. The coating 115 can adhere to the surface 110 of the object 105. The coating 115 can be a paint, spray, gloss, or other film adhered to the surface 110 of the object 105. The coating 115 can be formulated to withstand the pressure 135 exerted by the source 140, such as an external environment like a hypersonic environment, outer space, wet or underwater, or other such extreme environment. The coating 115 can be tuned to detect mechanical pressure at a specified threshold. The coating 115 can include microcapsules incorporated with commercially developed paint ingredients.

The microcapsules 120 and 125 can identify the pressure 135 exerted by the source 140. The microcapsules can be in a first state 120, a second state 125, or can be in any third or other state not depicted. The microcapsules in the first state 120 and in the second state 125 can include molecules such as polyurea-formaldehyde (resorcinol-doped shell) with hexyl acetate internal phase and fluorophore. In some cases, the microcapsules can include a water-soluble polyvinyl alcohol. In some cases, the microcapsules can include the polyvinyl alcohol and the fluorescent molecules in a ratio, such as 1:3 weight percent ratio. In some examples, the microcapsules may be oxygen impermeable. The coating 115 including the microcapsules in the first state 120 can be adhered to the surface 110 using spray-on or brush methods, among others. A binder may be utilized to facilitate spray-on application of the coating 115. The binder may serve as the luminescent sensor with the microcapsules 120, 125, the solvent, and the polymer binder forming the coating 115. The coating 115 may be a sprayable coating that includes fillers to facilitate formation of a sprayable glass composite with sufficient porosity for oxygen permeation to allow the excitation of the microcapsules from the first state to the second state. In at least one example, the spray gun used for spraying the coating 115 may be a High Volume, Low Pressure (HVLP) spray gun, and thus the binder may have a shear thinning viscosity profile. After curing, the sprayed film coating 115 is able to withstand >700° F. for a maximum of 500 milliseconds. In at least one example, the binder can be polyurethanes, catalyzed silicones, pre-ceramic polymers, or combinations thereof.

Upon an application of the pressure 135 outside of the threshold range of pressure of the coating 115, the microcapsules 120 in the first state can change to the microcapsules 125 in the second state. In some cases, where a mechanical imprint, pressure, or exertion is applied by the source 140, the first state microcapsules 120 can change to the second state microcapsules 125. In some cases, the first state microcapsules 120 are whole, unburst, or intact. In some cases, the second state microcapsules 125 are broken, burst, or otherwise have output some or all of the fluorescent molecules contained therein.

In some cases, the coating 115 is visible under illumination, such as, by exhibiting fluorescence. For example, the light 145 can emit, shine, or otherwise illuminate the coating 115. In some cases, the first state microcapsules 120 may appear differently (e.g., in color, reflectivity, intensity, etc.) than the second state microcapsules 125. For example, the second state microcapsules 125 can be visible by application of a light 145 within a threshold wavelength, such as ultraviolet, microwave, the visible light spectrum, etc. For example, the second state microcapsules 125 can be visible upon application of a 350-380 nm UV excitation source, such as the light 145.

In some cases, the microcapsules include the fluorescent molecules such that they form exciter pairs when solid but remains a monomer when dissolved in solution or solvent as described above. When the microcapsule ruptures (such as upon application of the pressure 135 by the source 140), the fluorescent molecules can be released. As the solvent evaporates, the molecules precipitate into solid form and can form excimer pairs. Under illumination, such as provided by the light 145, the intact capsules (e.g., the first state microcapsules) can emit a different color than the areas including the second state microcapsules 125 (e.g., where the microcapsules were ruptured).

In some cases, the first state microcapsules 120 and the second state microcapsules 125 can be captured in an image by the image capture device 150. Although one image capture device 150 is shown, any number of image capture devices 150 may be used collectively to obtain the images of the object 105 with the coating 115. The image capture device 150 can take pictures, images, videos, or other such captures to identify the location of the second state microcapsules and the first state microcapsules. In some cases, the image capture device 150 is continuously taking images. In some cases, the image capture device 150 is taking images responsive to a detection of the second state microcapsules as illuminated by the light 145. In some cases, the image capture device 150 can capture spatiotemporal optical measurements of the coating 115, such as illuminated by the light 145. In this manner, changes in pressure surrounding, enclosed by, or otherwise encountered by the object 105 can be detected and recorded in a variety of environments.

FIG. 2 illustrates a view 200 of detecting pressure changes in an object 105 with a pressure-sensitive coating 115 disposed on a surface 110 (e.g., walls) of the object 105. The view 200 includes the object 105 shown as a room, such as an airlock chamber, capsule, airplane cabin, vacuum-sealed chamber, or other such pressure-sensitive room, with the coating 115 on the walls 110 of the room. Without pressure 135 exerted on the object 105 (e.g., on the coating 115 on the walls 110), the microcapsules remain in the first state (as first state microcapsules 120, not shown in FIG. 2). Upon an exertion of the pressure 135 by the source 140, the coating 115 can exhibit second state microcapsules 125 to indicate the presence of the leak. In some cases, the source 140 of the pressure 135 can be a leak, such as caused by egresses, windows, doors, or other holes or byways from the object 105 to an outside environment. In some cases, the pressure 135 is a negative pressure. For example, the pressure 135 can be caused by air such as oxygen leaking from the source 140.

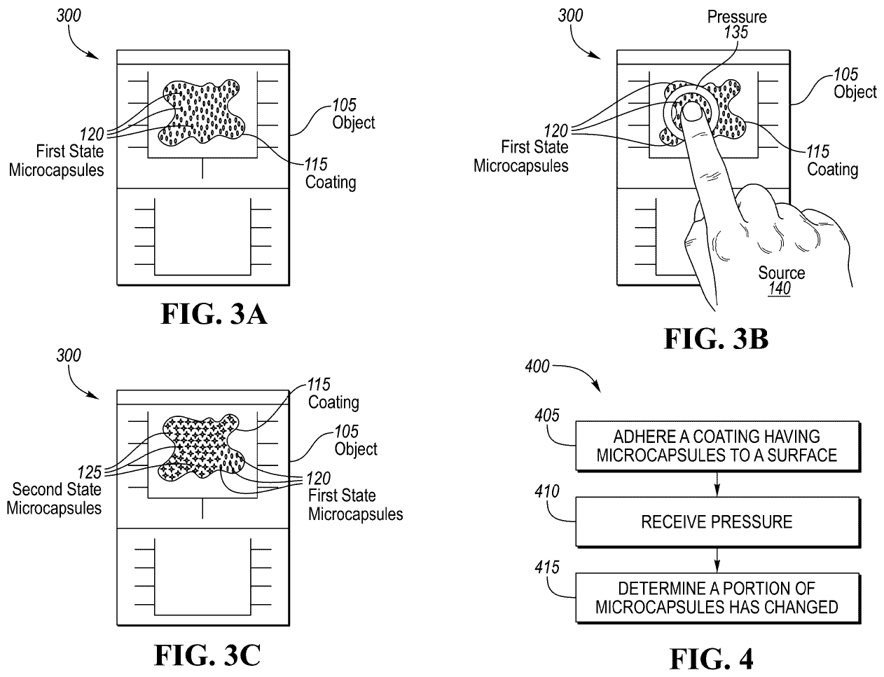

FIGS. 3A-3C illustrate a process 300 for detecting pressure changes in an object 105 with a pressure-sensitive coating 115. FIG. 3A illustrates the object 105 with the coating 115 with the first state microcapsules 120. The object 105 can be any object, such as an electronic device. The coating 115 can include the first state microcapsules 120 prior to the application of a pressure to the object 105. In some embodiments, the pressure 135 may fall outside of the threshold pressure range for the coating 115 for the first state microcapsules 120 to remain in the first state. FIG. 3B depicts the source 140 applying the pressure 135 by tampering with the object 105. For example, the source 140 can be a human, tool, or other device to tamper with, touch, or mishandle the object 105 such that a pressure outside of the threshold range of pressure is applied to the object 105. In this manner, the object 105 can be damaged, tampered with, or otherwise undergo a pressure sensitive handling. In FIG. 3C, after the application of the pressure 135, and the source 140 is removed, a portion of the first state microcapsules 120 have changed to the second state microcapsules 125 based on the application of the pressure 135 outside of the threshold range on a portion of the coating 115 of the object 105.

FIG. 4 illustrates a flow chart of a method 400 of detecting pressure sensitive changes with a pressure-sensitive coating. The method 400 includes Acts 405-415. The method 400 can include fewer or more acts than those depicted, and in any order or sequence, and FIG. 4 is provided as an example of the method 400. At Act 405, a coating having microcapsules is adhered to a surface. The surface can be a surface of an object, such as an airplane, a room, a device, a vehicle, among others. The coating can include microcapsules. In some cases, the microcapsules include a solvent and fluorescent molecules. The fluorescent molecules may be, in some examples, core-shell quantum dots such as, but not limited to cadmium-selenide/cadmium-sulfide quantum dots. The microcapsules may be dispersed in a suitable binder to form a coating, and the coating may include, in some embodiments, other fillers or components required to form an oxygen-permeable coating to allow for a change in state of the microcapsules upon exposure to a pressure differential and/or application of a pressure.

At Act 410, the object can receive pressure. The object can receive a pressure exerted thereon from a source such as an external environment, another object, a fluid, among others. In some cases, the pressure is continuously applied. In some cases, the pressure is applied for a period of time. The pressure may be applied to any portion of the object, and need not be uniformly applied to all parts of the object. The pressure can exceed, be under, or otherwise be outside of a range of threshold pressure for the coating. The coating can have a threshold pressure at which one or more microcapsules burst, are damaged, or otherwise change state. In some embodiments, at least a portion of the microcapsules may change state from a first state to a second state upon exertion of pressure. In further embodiments, the exertion of pressure may exceed a threshold in order to change state from the first state to the second state.

At Act 415, the method 400 can include determining that a portion of the microcapsules has changed. The portion of the microcapsules can change from a first state to a second state upon application of a pressure outside of the threshold range of pressure. The portion of the microcapsules which change (e.g., from the first state to the second state) can, in some cases, be made visible by application of a light. For example, illumination by an UV light can elucidate the portion of the coating subject to the pressure. In some cases, an image capture device can capture images of the coating to determine where the pressure has been or is currently applied to the coating. In some examples, the image capture device can visualize the microcapsules in both the first state and second state to depict which portions of the coating have changed from the first state to the second state.

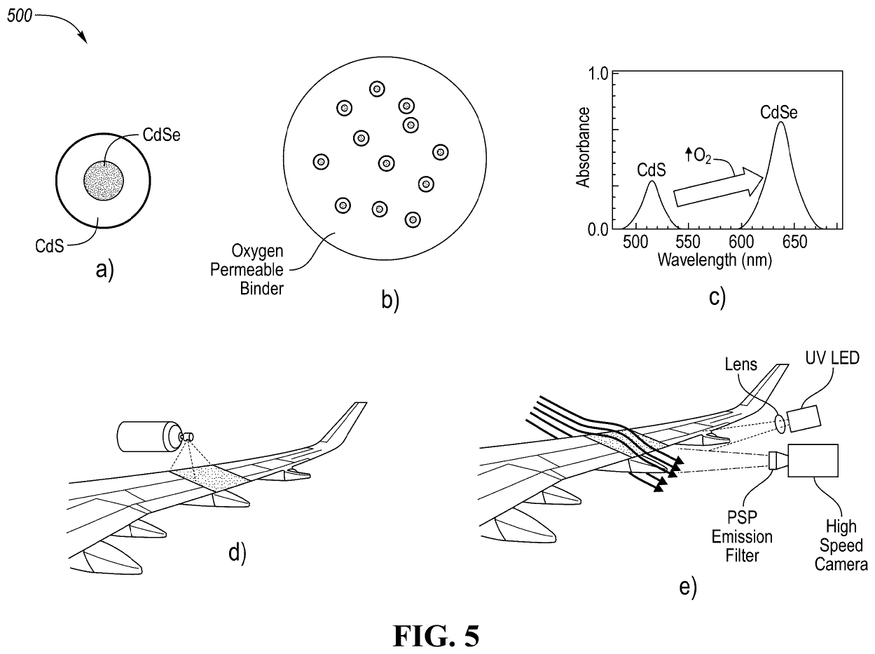

FIG. 5 illustrates a block diagram 500 of detecting pressure changes with a pressure-sensitive coating. The block diagram 500 includes a) an example microcapsule which can be included in a pressure-sensitive coating. The pressure-sensitive coating can include b) an oxygen permeable binder including a plurality of the microcapsules depicted in a). As depicted in a) the microcapsules may include an encapsulated quantum dot. In at least one example, the quantum dot may be a cadmium selenide based quantum dot, and in certain further embodiments may be a cadmium selenide-cadmium sulfide core shell quantum dot. As depicted in b), the oxygen permeable binder may be any suitable binder, such as, but not limited to, polyurethanes, catalyzed silicones, and pre-ceramic polymers. In examples where the binder is a polyurethane, the coating may result in a porous surface with functional fillers, low cure temperatures, and long shelf-life storage. In examples where the binder is a catalyzed silicone, the coating may exhibit a thermal stability (e.g., structurally stable upwards of 700° F.) for extended periods of time, may be sprayable, and additional fillers such as titania may be included in the coating Other silicates contemplated for the binder of the coating include the alumina-silicate and sodium-silicate classes of materials, or other silicates that are soluble in water and alcohols. The binder may allow for the coating to be a sprayable coating, and may include additional fillers to facilitate formation of an oxygen permeable sprayable glass composite. The coating may be curable through hydrolysis, and result in a surface with a thermal stability of 1800° F. The block diagram 500 includes a chart c). The chart c) depicts an example of a change of state of microcapsule. For example, the microcapsule in the first state can exhibit a lower wavelength than the microcapsules in the second state. In some cases, the microcapsule in the second state can exhibit higher fluorescence than the microcapsule in the first state. Thus, the second state may be distinct from the first state when reviewed visually, in some examples, under certain light, or via an image capture device. Moreover, the change of state as shown in the chart c) is related to the oxygen exposure to the microcapsules resulting in the quantum dots reaching an emission peak.

The block diagram 500 can include d) a depiction of application and/or adherence of the coating. At d), the coating is applied by a spray technique, although a brush, powder, dip, or other means of application of the coating can suffice. At e), an application of a pressure to an object with the coating is depicted. The object depicted in e) can encounter a pressure such as a Mach 5-10 flow. The depiction at e) can further exhibit a light, such as a UV LED, and an image capture device, such as a high-speed camera, for capturing a change in state of the microcapsules (e.g., a fluorescence exhibited upon changing from the first state to the second state).

Using the technical solution described herein, pressures exerted on an object can be detected. Pressures exerted by an external environment can be detected, recorded, or otherwise identified during both operation of an object and testing of an object. In this manner, pressures outside of a threshold range of pressure for an object can be tuned into a coating such as a pressure-sensitive paint, thereby enabling early and precise detection of fault, tamper, or pressure points of the object.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for detecting pressure changes, comprising:
an object having a surface;
a coating on at least a portion of the surface, the coating having microcapsules including encapsulated quantum dots and configured to:
receive an application of a pressure from a source; and
in response to the application of the pressure exceeding a threshold pressure, change at least a portion of the microcapsules from a first state to a second state; and
an image capture device positioned to capture images of the coating.

2. The system of claim 1, further comprising a light source configured to identify the portion of the microcapsules in the second state.

3. The system of claim 1, wherein the source comprises an external environment.

4. The system of claim 3, wherein the external environment comprises a hypersonic environment or a vacuum environment.

5. The system of claim 1, wherein the pressure is a mechanical pressure.

6. The system of claim 1, wherein the pressure is a vacuum pressure.

7. The system of claim 1, wherein the object is a room.

8. The system of claim 1, wherein the object is a vehicle.

9. The system of claim 1, wherein the object is an electronic device.

10. A method for detecting pressure changes, comprising:
applying a coating having microcapsules of encapsulated quantum dots to a surface of an object, the microcapsules having a first state and a second state exhibiting fluorescence; and
capturing an image of the surface; and
determining, based on the image, that at least a portion of the microcapsules changed from the first state to the second state.

11. The method of claim 10, wherein the image depicts areas of fluorescence of the coating.

12. The method of claim 10, wherein the determining includes detecting an emission peak having a sensitivity to oxygen.

13. The method of claim 10, further comprising applying a light on the surface.

14. A pressure sensitive coating comprising:
an oxygen-permeable binder; and
oxygen impermeable microcapsules dispersed in the oxygen-permeable binder, each microcapsule including an encapsulated core-shell quantum dot and having a first state and a second state,
wherein upon pressure application exceeding a threshold pressure, at least a portion of the microcapsules change from the first state to the second state and emit fluorescence such that a pressure change can be detected.

15. The pressure sensitive coating of claim 14, wherein the encapsulated core-shell quantum dot is a cadmium-selenide/cadmium-sulfide quantum dot.

16. The pressure sensitive coating of claim 14, wherein the oxygen permeable binder includes at least one of a polyurethane, a catalyzed silicone, a pre-ceramic polymers.

17. The pressure sensitive coating of claim 14, wherein the oxygen permeable binder is alumina silicate or sodium silicate.

18. The pressure sensitive coating of claim 14, wherein a fluorescence of the first state is a different wavelength from a fluorescence of the second state.

19. The pressure sensitive coating of claim 14, wherein the application of pressure includes exposure to a pressure differential via oxygen permeating into the coating to change the portion of the microcapsules from the first state to the second state.

20. The pressure sensitive coating of claim 14, wherein the second state is detected via application of light from a light source.
